(19) United States
(12) Patent Application Publication
(10) Pub. No.: US 2025/0179278 A1
(43) Pub. Date: Jun. 5, 2025

(54) POLYETHYLENE BLEND FOR A FILM LAYER

(71) Applicant: BOREALIS AG, Vienna (AT)

(72) Inventors: Jingbo WANG, Linz (AT); Friedrich BERGER, Linz (AT); Jani AHO, Porvoo (FI); Juulia HIRVONEN, Kulloo (FI)

(73) Assignee: BOREALIS AG, Vienna (AT)

(21) Appl. No.: 18/832,363

(22) PCT Filed: Jan. 24, 2023
(86) PCT No.: PCT/EP2023/051618

§ 371 Date: Jul. 23, 2024

(30) Foreign Application Priority Data
Jan. 28, 2022 (EP) 22153794.7

(51) Int. Cl. C08L 23/06; C08J 5/18

(52) U.S. Cl. CPC C08L 23/06; C08J 5/18; C08J 2323/06; C08J 2423/08; C08L 2203/16; C08L 2205/035; C08L 2207/066

(57) ABSTRACT

Disclosed is a polyethylene blend of a specific multimodal metallocene catalysed linear low density polyethylene (mLLDPE) and a low density polyethylene (LDPE), which provides films with high dart drop (impact strength), and well-balanced overall performance.

The present invention relates to a polyethylene blend of a specific multimodal metallocene catalysed linear low density polyethylene (mLLDPE) and a low density polyethylene (LDPE), which provides films with high dart drop (impact strength), and well-balanced overall performance.

High standards are nowadays required for packaging materials. Quite often properties are required in the packaging industry, which are conflicting. Typically, high stiffness and toughness are required in parallel. To achieve these different properties seldom pure components, but rather combinations of different polymer components are used. Two different approaches mainly are at the skilled person's disposal: (a) blends of two or more polymers to form a heterophasic structure, or (b) producing a multilayer structure with different materials providing different functions. Both of them are applied in industry.

Due to the different requirements nowadays multilayer packaging with different type of materials are used, which from one side serve the needs, but from the other side such structures make recycling difficult. Therefore using pure materials is preferred, i.e. a packaging with ‘mono-materials’, i.e. only polyethylene based polymers, is really appreciated. However, this imposes higher requirement to the performance of materials themselves, a material with balanced performance is therefore highly appreciated.

mLLDPE attracts specific interests due to its excellence balance between cost and performance. The main drawback is that the processability and optics are rather poor. One common way is to blend the mLLDPE with LDPE, however, this is known to worsen other properties, like impact.

As stated above the recycling of packaging material after their first use is an important topic nowadays. It is much more challenging to recycle packaging films made of different materials, e.g. different plastics, than to recycle mono-material solutions. On the other hand, the use of different materials is sometimes necessary to obtain acceptable properties, like mechanical properties. Therefore, an objective of the present invention is the provision of a polyethylene based mono-material solution, which provides improved mechanical properties, especially dart drop (impact strength).

In other words, blends are desirable that provide an advantageous combination of tensile modulus and dart drop to films prepared from such blends.

In addition, such films should further show a well-balanced and continuously improved overall performance.

Such an improvement in the overall performance of a film, preferably blown film, can be expressed by the optomechanical ability (OMA), which is the ratio of mechanical (especially dart-drop impact strength (DDI) and tensile (MD)) behaviour, to optical performance, namely haze.

The present inventors have found that a blend of a specific multimodal metallocene catalysed linear low density polyethylene (mLLDPE) and a low density polyethylene (LDPE), provides films with well-balanced properties, especially dart drop (impact strength), tensile modulus and haze.

Summary of Invention

The present invention is therefore directed to a polyethylene blend comprising
a) 60.0 wt % to 95.0 wt %, based on the total weight of the polyethylene blend, of a multimodal metallocene catalysed linear low density polyethylene (mLLDPE) which consists of
(i) 30.0 to 70.0 wt % of an ethylene-1-butene polymer component (A), and
(ii) 70.0 to 30.0 wt % of an ethylene-1-hexene polymer component (B),
whereby the ethylene-1-butene polymer component (A) has
   a density in the range of 930 to 955 kg/m³,
   a MFR₂ (190° C., 2.16 kg, ISO 1133) in the range of 20.0 to 400.0 g/10 min, and
the ethylene polymer component (B) has
   a density in the range of 880 to 915 kg/m³,
   a MFR₂ (190° C., 2.16 kg, ISO 1133) in the range of 0.001 to 0.1 g/10 min
whereby the multimodal metallocene catalysed linear low density polyethylene (mLLDPE) has
   a density in the range of 905 to 930 kg/m³,
   a MFR₂ (190° C., 2.16 kg, ISO 1133) in the range of 0.10 to 0.90 g/10 min,
   a ratio of the MFR₂₁ (190° C., 21.6 kg, ISO 1133) to MFR₂ (190° C., 2.16 kg, ISO 1133),
   MFR₂₁/MFR₂, in the range of from 22 to 100 and
   a ratio of the MFR₂ of the ethylene-1-butene polymer component (A) to the MFR₂ of the mLLDPE is in the range of 15.0 to 300; and
b) 5.0 to 40.0 wt %, based on the total weight of the polyethylene blend, of a low density polyethylene (LDPE) whereby said LDPE has
   a density in the range of 910 to 930 kg/m³; and
   a MFR₂ (190° C., 2.16 kg, ISO 1133) in the range of 0.1 to 30.0 g/10 min.

In an embodiment of the present invention, the ethylene-1-butene polymer component (A) of the multimodal metallocene catalysed linear low density polyethylene (mLLDPE) consists of an ethylene polymer fraction (A-1) and an ethylene polymer fraction (A-2).

Unexpectedly the above defined blend of the invention provides an advantageous combination of tensile modulus and dart drop to films prepared from such blends.

In addition, such films further show a well-balanced and improved overall performance expressed by an improved optomechanical ability (OMA).

The invention is therefore further direct to films comprising the above defined polyethylene blend.

### DEFINITIONS

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

Metallocene catalysed linear low density polyethylene (mLLDPE) is defined in this invention as linear low density polyethylene copolymer, which has been produced in the presence of a metallocene catalyst.

For the purpose of the present invention “metallocene catalysed linear low density polyethylene (mLLDPE) which consists of an ethylene-1-butene polymer component (A) and an ethylene-1-hexene polymer component (B)” means that the mLLDPE is produced in an at least 2-stage sequential polymerization process, wherein first component (A) is produced and component (B) is then produced in the presence of component (A) in a subsequent polymerization step, yielding the mLLDPE or vice versa, i.e. first component (B) is produced and component (A) is then produced in the presence of component (B) in a subsequent polymerization step, yielding the mLLDPE.

Low density polyethylene (LDPE) is defined in this invention as low density polyethylene copolymer, which has been produced in a high-pressure process.

Term “multimodal” in context of multimodal metallocene catalysed linear low density polyethylene means herein multimodality with respect to melt flow rate (MFR)) of at least the ethylene polymer components (A) and (B), i.e. the ethylene polymer components (A) and (B), have different MFR values. The multimodal metallocene catalysed linear low density polyethylene can have further multimodality between the ethylene polymer components (A) and (B) with respect to one or more further properties, like density, comonomer type and/or comonomer content, as will be described later below.

### DETAILED DESCRIPTION OF INVENTION

The polyethylene blend according to the present invention comprises a) a multimodal metallocene catalysed linear low density polyethylene (mLLDPE) and b) a low density polyethylene (LDPE).

Thus the blend comprises
a) 60.0 wt % to 95.0 wt %, preferably 65.0 wt % to 93.0 wt %, more preferably 75.0 wt % to 92.0 wt % and even more preferably 80.0 wt % to 92.0 wt %, based on the total weight of the polyethylene blend, of the multimodal metallocene catalysed linear low density polyethylene (mLLDPE) and
b) 5.0 to 40.0 wt %, preferably 7.0 wt % to 35.0 wt %, more preferably 8.0 wt % to 25.0 wt % and even more preferably 8.0 wt % to 20.0 wt %, based on the total weight of the polyethylene blend, of a low density polyethylene (LDPE).

In an embodiment the blend consists of a) and b) only, thus the total amounts of a)+b) summing up to 100 wt %.

### Ad Multimodal Metallocene Catalysed Linear Low Density Polyethylene (mLLDPE)

The multimodal metallocene catalysed linear low density polyethylene (mLLDPE) is referred herein as “multimodal”, since the ethylene-1-butene polymer component (A), optionally including ethylene polymer fractions (A-1) and (A-2), and ethylene-1-hexene polymer component (B) have been produced under different polymerization conditions resulting in different Melt Flow Rates (MFR, e.g. MFR₂). I.e. the multimodal PE is multimodal at least with respect to difference in MFR of the ethylene polymer components (A) and (B).

The multimodal metallocene catalysed linear low density polyethylene (mLLDPE) consists of
(i) 30.0 to 70.0 wt %, based on the mLLDPE, of an ethylene-1-butene polymer component (A), and
(ii) 70.0 to 30.0 wt %, based on the mLLDPE, of an ethylene-1-hexene polymer component (B).

The amount of (A) and (B) add up to 100.0 wt %.

In an embodiment of the present invention, the ethylene-1-butene polymer component (A) consists of an ethylene polymer fraction (A-1) and (A-2).

It is possible that fraction (A-1) is produced first and then fraction (A-2) is produced in the presence of fraction (A-1) in a subsequent reactor or vice versa, i.e. fraction (A-2) is produced first and then fraction (A-1) is produced in the presence of fraction (A-2) in a subsequent reactor. Preferably fraction (A-1) is produced first.

In case that the ethylene-1-butene polymer component (A) consists of ethylene polymer fractions (A-1) and (A-2), the MFR2 of the ethylene polymer fractions (A-1) and (A-2) may be different from each other.

Thus, the ethylene polymer fractions (A-1) and (A-2) have a MFR₂ (190° C., 2.16 kg, ISO 1133) in the range of 10.0 to 800.0 g/10 min, preferably of 15.0 to 400.0 g/10 min, more preferably of 20.0 to 300.0 g/10 min and even more preferably of 25.0 to 200.0 g/10 min, like 30.0 to 150.0 g/10 min.

The MFR₂ of the ethylene polymer components (A) and (B) are different from each other.

The ethylene polymer component (A) has a MFR₂ (190° C., 2.16 kg, ISO 1133) in the range of 20.0 to 400 g/10 min, preferably of 25.0 to 300 g/10 min, more preferably of 30.0 to 250 g/10 min, even more preferably of 32.0 to 200 g/10 min and still more preferably of 35.0 to 150.0 g/10 min, like 40.0 to 140.0 g/10 min.

The ethylene polymer component (B) has a MFR₂ (190° C., 2.16 kg, ISO 1133) in the range of 0.001 to 0.1 g/10 min, preferably of 0.005 to 0.09 g/10 min, more preferably of 0.008 to 0.08 g/10 min and even more preferably of 0.01 to 0.06 g/10 min.

The MFR₂ (190° C., 2.16 kg, ISO 1133) of the multimodal metallocene catalysed linear low density polyethylene (mLLDPE) is in the range of 0.10 to 0.90 g/10 min, preferably 0.20 to 0.80 g/10 min, more preferably 0.30 to 0.70 g/10 min.

The multimodal metallocene catalysed linear low density polyethylene (mLLDPE) has a ratio of the MFR₂₁ (190° C., 21.6 kg, ISO 1133) to MFR₂ (190° C., 2.16 kg, ISO 1133), MFR₂₁/MFR₂, in the range of from 22 to 100, preferably from 25 to 60, more preferably from 30 to 50 and even more preferably from 35 to 45.

In an embodiment of the invention it is preferred the ratio of the MFR₂ (190° C., 2.16 kg, ISO 1133) of the ethylene-1-butene polymer component (A) to the MFR₂ (190° C., 2.16 kg, ISO 1133) of the final multimodal metallocene catalysed linear low density polyethylene (mLLDPE) is in the range of 15.0 to 300, preferably 30.0 to 250, more preferably of 40.0 to 200 and even more preferably of 50.0 to 160.

Naturally, in addition to multimodality with respect to, i.e. difference between, the MFR₂ of ethylene polymer components (A) and (B), the multimodal PE of the invention can also be multimodal e.g. with respect to one or both of the two further properties:
multimodality with respect to, i.e. difference between,
the comonomer content(s) present in the ethylene polymer components (A) and (B); and/or
the density of the ethylene polymer components (A) and (B).

Preferably, the multimodal metallocene catalysed linear low density polyethylene (mLLDPE) is further multimodal with respect to the comonomer content of the ethylene polymer components (A) and (B).

The comonomer type for the polymer fractions (A-1) and (A-2) is the same, thus both fractions therefore have 1-butene as comonomer.

The comonomer content of component (A) and (B) can be measured, or, in case, and preferably, one of the components is produced first and the other thereafter in the presence of the first produced in so called multistage process, then the comonomer content of the first produced component, e.g. component (A), can be measured and the comonomer content of the other component, e.g. component (B), can be calculated according to following formula:

Comonomer content (wt %) in component B=(comonomer content (wt %) in final product−(weight fraction of component A*comonomer content (wt %) in component A))/(weight fraction of component B)

The total amount of 1-butene, based on the multimodal metallocene catalysed linear low density polyethylene (mLLDPE) is preferably in the range of from 0.1 to 2.5 wt %, preferably 0.2 to 2.0 wt % and more preferably 0.3 to 1.8 wt %.

The total amount of 1-hexene, based on the multimodal metallocene catalysed linear low density polyethylene (mLLDPE) preferably is in the range of 2.0 to 20.0 wt %, preferably 4.0 to 18.0 wt % and more preferably 6.0 to 15.0 wt %.

The total amount (wt %) of 1-butene, present in the ethylene-1-butene polymer component (A) is of 0.5 to 5.0 wt %, preferably of 0.8 to 4.0 wt %, more preferably of 1.0 to 3.5 wt %, even more preferably of 1.5 to 3.0 wt %, based on the ethylene-1-butene polymer component (A).

The total amount (wt %) of 1-hexene, present in the ethylene-1-hexene polymer component (B) is of 8.0 to 25.0 wt %, preferably of 10.0 to 22.0 wt %, more preferably of 12.0 to 20.0 wt %, based on the ethylene-1-hexene polymer component (B).

Even more preferably the multimodal metallocene catalysed linear low density polyethylene (mLLDPE) of the invention is further multimodal with respect to difference in density between the ethylene polymer component (A) and ethylene polymer component (B). Preferably, the density of ethylene polymer component (A) is different, preferably higher, than the density of the ethylene polymer component (B).

The density of the ethylene polymer component (A) is in the range of 930 to 955 kg/m³, preferably of 935 to 950 kg/m³, more preferably 938 to 945 kg/m³ and/or the density of the ethylene polymer component (B) is of in the range of 880 to 915 kg/m³, preferably of 885 to 910 kg/m³ and more preferably of 888 to 905 kg/m³.

The polymer fraction (A-1) has a density in the range of from 920 to 955 kg/m³, preferably of 925 to 950 kg/m³, more preferably of 930 to 948 kg/m³, like 935 to 945 kg/m³.

The density of the polymer fraction (A-2) is in the range of from 930 to 955 kg/m³, preferably of 935 to 950 kg/m³, like 938 to 945 kg/m³.

The density of the multimodal metallocene catalysed linear low density polyethylene (mLLDPE) is in the range of 905 to 930 kg/m³, preferably of 908 to 925 kg/m³ and more preferably of 910 to 920 kg/m³.

More preferably the multimodal metallocene catalysed linear low density polyethylene (mLLDPE) is multimodal at least with respect to, i.e. has a difference between, the MFR₂, the comonomer content as well as with respect to, i.e. has a difference between the density of the ethylene polymer components, (A) and (B), as defined above, below or in the claims including any of the preferable ranges or embodiments of the polymer composition.

It is within the scope of the invention, that the first and the second ethylene polymer fraction (A-1 and A-2) of the ethylene polymer component (A) are present in a weight ratio of 4:1 up to 1:4, such as 3:1 to 1:3, or 2:1 to 1:2, or 1:1.

The ethylene polymer component (A) is present in an amount of 30.0 to 70.0 wt % based on the multimodal metallocene catalysed linear low density polyethylene (mLLDPE), preferably in an amount of 32.0 to 55.0 wt % and even more preferably in an amount of 34.0 to 45.0 wt %. Thus, the ethylene polymer component (B) is present in an amount of 70.0 to 30.0 wt % based on the multimodal metallocene catalysed linear low density polyethylene (mLLDPE), preferably in an amount of 68.0 to 45.0 wt % and more preferably in an amount of 66.0 to 55.0 wt %.

The multimodal metallocene catalysed linear low density polyethylene (mLLDPE), can be produced in a 2-stage process, preferably comprising a slurry reactor (loop reactor), whereby the slurry (loop) reactor is connected in series to a gas phase reactor (GPR), whereby either ethylene component (A) or ethylene component (B) is produced in the loop reactor and the other ethylene polymer component is then produced in GPR in the presence of the first produced ethylene polymer component to produce the multimodal metallocene catalysed linear low density polyethylene (mLLDPE), preferably the ethylene polymer component (A) is produced in the loop reactor and the ethylene polymer component (B) is produced in GPR in the presence of the ethylene polymer component (A) to produce the multimodal metallocene catalysed linear low density polyethylene (mLLDPE).

In case that the ethylene component (A) of the multimodal metallocene catalysed linear low density polyethylene (mLLDPE) consists of ethylene polymer fractions (A-1) and (A-2), the multimodal metallocene catalysed linear low density polyethylene (mLLDPE) can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). It is possible that fraction (A-1) is produced first and then fraction (A-2) is produced in the presence of fraction (A-1) in a subsequent reactor or vice versa, i.e. fraction (A-2) is produced first and then fraction (A-1) is produced in the presence of fraction (A-2) in a subsequent reactor. Preferably fraction (A-1) is produced first.

The loop reactor 2 is thereby connected in series to a gas phase reactor (GPR), so that the first ethylene polymer component (A) leaving the second slurry reactor is fed to the GPR to produce a trimodal polyethylene copolymer. In this case, the reaction conditions in the two slurry reactors are chosen in a way that in the two slurry reactors different products in view of MFR and/or density are produced.

Such a process is described inter alia in WO 2016/198273, WO 2021009189, WO 2021009190, WO 2021009191 and WO 2021009192. Full details of how to prepare suitable multimodal metallocene catalysed linear low density polyethylene (mLLDPE) can be found in these references.

A suitable process is the Borstar PE process or the Borstar PE 3G process.

The multimodal metallocene catalysed linear low density polyethylene (mLLDPE) according to the present invention is therefore preferably produced in a loop loop gas cascade. Such polymerization steps may be preceded by a prepolymerization step. The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step is preferably conducted in slurry and the amount of polymer produced in an optional prepolymerization step is counted to the amount (wt %) of ethylene polymer component (A).

The catalyst components are preferably all introduced to the prepolymerization step when a prepolymerization step is present. However, where the solid catalyst component and the cocatalyst can be fed separately it is possible that only a part of the cocatalyst is introduced into the prepolymerization stage and the remaining part into subsequent polymerization stages. Also in such cases it is necessary to introduce so much cocatalyst into the prepolymerization stage that a sufficient polymerization reaction is obtained therein.

It is understood within the scope of the invention, that the amount or polymer produced in the prepolymerization lies within 1 to 5 wt % in respect to the final metallocene catalysed multimodal metallocene catalysed linear low density polyethylene (mLLDPE). This can counted as part of the first ethylene polymer component (A).

### Catalyst

The multimodal metallocene catalysed linear low density polyethylene (mLLDPE) used in the process of the invention is one made using a metallocene catalyst. A metallocene catalyst comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the organometallic compound (C) has the following formula (I):

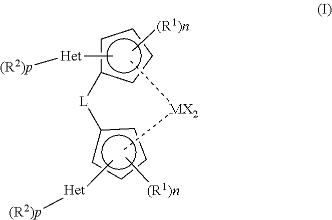

wherein each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

Preferably, the compound of formula (I) has the structure

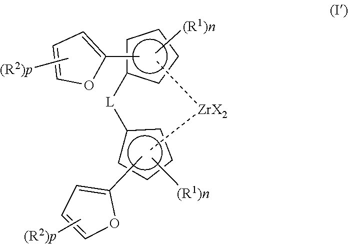

wherein each X is independently a halogen atom, a C₁₋₆-alkyl group, C₁₋₆-alkoxy group, phenyl or benzyl group;
L is a Me₂Si—;
each R¹ is the same or different and is a C₁₋₆-alkyl group, e.g. methyl or t-Bu;
each n is 1 to 2;
R² is a —Si(R)₃ alkyl group; each p is 1;
each R is C₁₋₆-alkyl or phenyl group.

Highly preferred complexes of formula (I) are

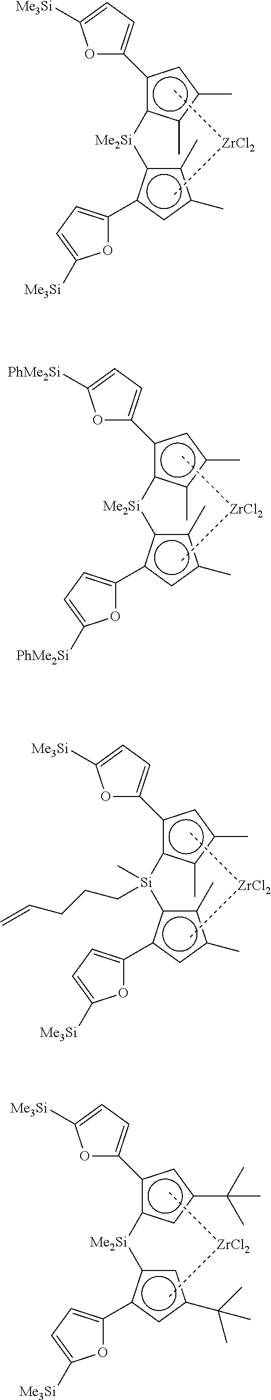

Most preferably the complex dimethylsilanediylbis[2-(5-trimethylsilylfuran-2-yl)-4,5-dimethylcyclopentadien-1-yl] zirconium dichloride is used.

More preferably the ethylene polymer components (A) and (B) of the multimodal metallocene catalysed linear low density polyethylene (mLLDPE) are produced using, i.e. in the presence of, the same metallocene catalyst.

To form a catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred. Polyethylene copolymers made using single site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

The multimodal metallocene catalysed linear low density polyethylene (mLLDPE) may contain further polymer components and optionally additives and/or fillers. In case the multimodal metallocene catalysed linear low density polyethylene (mLLDPE) contains further polymer components, then the amount of the further polymer component(s) typically varies between 3.0 to 20.0 wt % based on the combined amount of the multimodal metallocene catalysed linear low density polyethylene (mLLDPE) and the other polymer component(s).

The optional additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

It is understood herein that any of the additives and/or fillers can optionally be added in so-called master batch, which comprises the respective additive(s) together with a carrier polymer. In such case the carrier polymer is not calculated to the polymer components of the multimodal metallocene catalysed linear low density polyethylene (mLLDPE), but to the amount of the respective additive(s), based on the total amount of the multimodal metallocene catalysed linear low density polyethylene (mLLDPE) (100 wt %).

### Ad Low Density Polyethylene (LDPE)

The polyethylene blend according to the present invention comprises as component a) a LDPE; whereby said LDPE has a density determined according to ISO 1183 in the range of 910 to 930 kg/m³; and a MFR₂ (190° C., 2.16 kg, ISO 1133) in the range of 0.1 to 30.0 g/10 min.

The MFR₂ (190° C., 2.16 kg, ISO 1133) is preferably in the range of 0.3 to 30.0 g/10 min, more preferably in the range of 1.0 to 25.0 g/10 min, even more preferably in the range of 5.0 to 20.0 g/10 min.

The density determined according to ISO 1183 of the LDPE is preferably in the range of 910 to 930 kg/m³, more preferably in the range of 912 to 925 kg/m³ and even more preferably in the range of 914 to 920 kg/m³.

Suitable LDPEs preferably have a comonomer content of 0.0 wt % to less than 15.0 wt %, more preferably of 0.0 wt % to less than 10.0 wt %, even more preferably of 0.0 wt % to less than 5.0 wt % and still more preferably 0.0 wt % to 1.0 wt %.

The low density polyethylene (LDPE) preferably is a low density homopolymer of ethylene (referred herein as LDPE homopolymer).

LDPEs are well known in the art and are produced in high pressure process usually performed in a tubular reactor or an autoclave.

Polymerization in tubular or autoclave reactors is well known and well documented in the literature in the polymerization field.

Such LDPEs typically contain long chain branching which differentiates LDPEs from linear low-density polyethylenes, LLDPEs.

Suitable LDPE's are available commercially from Borealis, Basell, Exxon, Sabic, or other suppliers.

Preferred LDPEs for component b) are inter alia commercially available from Borealis AG (Austria) under the trade names CA9150, CT7200, FT5230 and LE6600-PH, especially CA9150.

As mentioned above, the polyethylene blend according to the present invention provides an advantageous combination of tensile modulus and dart drop to films prepared from such blends.

In addition, such films further show a well-balanced and improved overall performance expressed by an improved optomechanical ability (OMA).

The invention is therefore further direct to films comprising the above defined polyethylene blend.

### Film

The film of the invention comprises at least one layer comprising the above defined polyethylene blend. The film can be a monolayer film comprising the above defined polyethylene blend or a multilayer film, wherein at least one layer comprises the above defined polyethylene blend. The terms “monolayer film” and multilayer film” have well known meanings in the art.

The films are preferably produced by any conventional film extrusion procedure known in the art including cast film and blown film extrusion. Most preferably, the film is a blown or cast film, especially a blown film. E.g. the blown film is produced by extrusion through an annular die and blowing into a tubular film by forming a bubble which is collapsed between nip rollers after solidification. This film can then be slit, cut or converted (e.g. gusseted) as desired. Conventional film production techniques may be used in this regard. If the preferable blown or cast film is a multilayer film then the various layers are typically coextruded. The skilled man will be aware of suitable extrusion conditions.

Films according to the present invention may be subjected to post-treatment processes, e.g. surface modifications, lamination or orientation processes or the like. Such orientation processes can be mono-axially (MDO) or bi-axially orientation, wherein mono-axial orientation is preferred.

In another preferred embodiment, the films are unoriented.

Preferred films according to the invention are monolayer blown films.

The monolayer film of the invention may have a thickness of 20 to 120 μm, preferably 30 to 100 μm and more preferably 35 to 80 μm. Films of the invention are preferably not stretched in the machine or transverse or biaxial direction.

The films of the invention are characterized by a dart-drop impact strength (DDI) determined according to ASTM D1709, method A on a 40 μm monolayer test blown film of at least 1300 g to >1790 g, preferably 1400 g to >1790 g and more preferably 1500 g to >1790 g. The upper limit of >1790 g is due to the upper detection limit of 1790 g of the respective method.

Films according to the present invention furthermore have good stiffness (tensile modulus measured on a 40 μm monolayer test blown film according to ISO 527-3), i.e. >160 MPa (in both directions).

Thus, the films according to the present invention may further have a tensile modulus (measured on a 40 μm monolayer test blown film according to ISO 527-3) in machine (MD) as well as in transverse (TD) direction in the range of from >160 MPa to 350 MPa, preferably of from 180 MPa to 300 MPa.

In addition or alternatively films according to the present invention may have good optics, i.e. haze (measured on a 40 um monolayer test blown film according to ASTM D 1003-00) of below 25%. Thus, the films comprising the polyethylene blend as described above may have a haze (measured on a 40 um monolayer test blown film according to ASTM D 1003-00) of below 25%, preferably between 5% and 20%, more preferably between 8% and 18%.

In one embodiment of the present invention, the optomechanical ability (OMA) according to formula (II):

$$O M A = \frac{Tensile Modulus ( MD ) [ MPa ] * DDI ( g )}{Haze ( 40 µm ) [ \% ]}$$

determined on 40 μm test blown film is at least 20000 [MPa*g/%] up to 50000 [MPa*g/%], preferably in the range of from 22000 [MPa*g/%] up to 45000 [MPa*g/%], more preferably in the range of from 23000 [MPa*g/%] up to 40000 [MPa*g/%], wherein the Tensile Modulus in machine direction is measured according to ISO 527-3 at 23° C. on 40 μm test blown films, DDI is the dart-drop impact strength determined according to ASTM D1709, method A on a 40 μm test blown film and haze is measured according to ASTM D1003 on a 40 μm test blown film.

Thus, in another preferred embodiment, the films comprising the polyethylene blend as described above, are characterized by
a) a dart-drop impact strength (DDI) determined according to ASTM D1709, method A on a 40 μm monolayer test blown film of at least 1300 g to >1790 g, preferably 1400 g to >1790 g and more preferably 1500 g to >1790 g, and
b) a tensile modulus (measured on a 40 μm monolayer test blown film according to ISO 527-3) in machine (MD) as well as in transverse (TD) direction in the range of from >160 MPa to 350 MPa, preferably of from 180 MPa to 300 MPa, and/or, preferably and
c) an optomechanical ability (OMA) according to formula (II):

$$OMA = \frac{Tensile Modulus ( MD ) [ MPa ] * DDI ( g )}{Haze ( 40 µm ) [ \% ]}$$

determined on 40 μm test blown film is at least 20000 [MPa*g/%] up to 50000 [MPa*g/%], preferably in the range of from 22000 [MPa*g/%] up to 45000 [MPa*g/%], more preferably in the range of from 23000 [MPa*g/%] up to 40000 [MPa*g/%], wherein the Tensile Modulus in machine direction is measured according to ISO 527-3 at 23° C. on 40 μm test blown films, DDI is the dart-drop impact strength determined according to ASTM D1709, method A on a 40 μm test blown film and haze is measured according to ASTM D1003 on a 40 μm test blown film.

The inventive films are fully recyclable and thus improves sustainability, as it is in the most preferred embodiment a “100% PE” solution with no other polymer than ethylene based polymers being present.

In another embodiment the inventive film contains at least 90 wt % of PE polymers, more preferably 95 to 99 wt % of PE polymers (difference to 100 wt % can be other polymers than PE), and is thus also suitable for being recycled.

The films according to the present invention are highly useful for being used in various packaging applications, wherein applications related to food packaging are preferred. Furthermore the films according to the present invention may be used as a layer in multilayer polyethylene based blown films, preferably as core layer in multilayer polyethylene based blown films.

The invention will be further described with reference to the following non-limiting examples.

### Determination Methods

Unless otherwise stated in the description or in the experimental part, the following methods were used for the property determinations of the polymers (including its fractions and components) and/or any sample preparations thereof as specified in the text or experimental part.

### Melt Flow Rate

The melt flow rate (MFR) was determined according to ISO 1133 and is indicated in g/10 min. The MFR is an indication of the flowability, and hence the processability, of the polymer. The higher the melt flow rate, the lower the viscosity of the polymer. The MFR is determined at 190° C. for polyethylene. MFR may be determined at different loadings such as 2.16 kg (MFR₂), 5 kg (MFR₅) or 21.6 kg (MFR₂₁).

Calculation of MFR₂ of Component B and of Fraction (A-2)

$$log A = x \cdot log B + ( 1 - x ) \cdot log C$$

$$C = 10 {\hat{}}^{\frac{( logA - x . logB )}{( 1 - x )}}$$

### For Component B:

B=MFR₂ of Component (A)
C=MFR₂ of Component (B)
A=final MFR₂ (mixture) of multimodal metallocene catalysed linear low density polyethylene (mLLDPE)
X=weight fraction of Component (A)

### For Fraction (A-2):

B=MFR₂ of 1^{st} fraction (A-1)
C=MFR₂ of 2^{nd} fraction (A-2)
A=final MFR₂ (mixture) of loop polymer (=Component (A))
X=weight fraction of the 1^{st} fraction (A-1).

### Density

Density of the polymer was measured according to ISO 1183-1.

### Comonomer Contents:

### Quantification of Microstructure by NMR Spectroscopy

Quantitative nuclear-magnetic resonance (NMR) spectroscopy was used to quantify the comonomer content of the polymers.

Quantitative ¹³C{¹H} NMR spectra recorded in the molten-state using a Bruker Advance III 500 NMR spectrometer operating at 500.13 and 125.76 MHz for ¹H and ¹³C respectively. All spectra were recorded using a ¹³C optimised 7 mm magic-angle spinning (MAS) probehead at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification.{klimke06, parkinson07, castignolles09} Standard single-pulse excitation was employed utilising the NOE at short recycle delays{pollard04, klimke06} and the RS-HEPT decoupling scheme{fillip05, griffin07}. A total of 1024 (1k) transients were acquired per spectra. Quantitative ¹³C{¹H} NMR spectra were processed, integrated and relevant quantitative properties determined from the integrals. All chemical shifts are internally referenced to the bulk methylene signal (δ+) at 30.00 ppm.

The amount of ethylene was quantified using the integral of the methylene (8+) sites at 30.00 ppm accounting for the number of reporting sites per monomer:

$$E = {I}_{δ +} / 2$$

the presence of isolated comonomer units is corrected for based on the number of isolated comonomer units present:

$$Etotal = E + ( 3 * B + 2 * H ) / 2$$

where B and H are defined for their respective comonomers. Correction for consecutive and non-consecutive commoner incorporation, when present, is undertaken in a similar way. Characteristic signals corresponding to the incorporation of 1-butene were observed and the comonomer fraction calculated as the fraction of 1-butene in the polymer with respect to all monomer in the polymer:

$$fBtotal = ( Btotal / ( Etotal + Btotal + Htotal )$$

The amount isolated 1-butene incorporated in EEBEE sequences was quantified using the integral of the _{*}B2 sites at 38.3 ppm accounting for the number of reporting sites per comonomer:

B=I_{*B2}

The amount consecutively incorporated 1-butene in EEBBEE sequences was quantified using the integral of the ααB2B2 site at 39.4 ppm accounting for the number of reporting sites per comonomer:

$$BB = 2 * I αα B 2 B 2$$

The amount non consecutively incorporated 1-butene in EEBEBEE sequences was quantified using the integral of the ββB2B2 site at 24.7 ppm accounting for the number of reporting sites per comonomer:

$$BEB = 2 * I ββ B 2 B 2$$

Due to the overlap of the *B2 and *βB2B2 sites of isolated (EEBEE) and non-consecutivly incorporated (EEBEBEE) 1-butene respectively the total amount of isolated 1-butene incorporation is corrected based on the amount of non-consecutive 1-butene present:

$$B = {I}_{* B 2} - 2 * {I}_{β β B 2 B 2}$$

The total 1-butene content was calculated based on the sum of isolated, consecutive and non consecutively incorporated 1-butene:

$$Btotal = B + BB + BEB$$

The total mole fraction of 1-butene in the polymer was then calculated as:

$$fB = ( Btotal / ( Etotal + Btotal + Htotal )$$

Characteristic signals corresponding to the incorporation of 1-hexene were observed and the comonomer fraction calculated as the fraction of 1-hexene in the polymer with respect to all monomer in the polymer:

$$fHtotal = ( Htotal / ( Etotal + Btotal + Htotal )$$

The amount isolated 1-hexene incorporated in EEHEE sequences was quantified using the integral of the _{*}B4 sites at 39.9 ppm accounting for the number of reporting sites per comonomer:

H=I_{*B4}

The amount consecutively incorporated 1-hexene in EEHHEE sequences was quantified using the integral of the ααB4B4 site at 40.5 ppm accounting for the number of reporting sites per comonomer:

$$HH = 2 * I αα B 4 B 4$$

The amount non consecutively incorporated 1-hexene in EEHEHEE sequences was quantified using the integral of the ββB4B4 site at 24.7 ppm accounting for the number of reporting sites per comonomer:

$$HEH = 2 * I ββ B 4 B 4$$

The total mole fraction of 1-hexene in the polymer was then calculated as:

$$fH = ( H total / ( E total + B total + H total )$$

The mole percent comonomer incorporation is calculated from the mole fraction:

$$B [ mol \% ] = 100 * fB$$

$$H [ mol \% ] = 100 * fH$$

The weight percent comonomer incorporation is calculated from the mole fraction:

$$B [ wt \% ] = 100 * ( fB * 56.11 ) / ( ( fB * 56.11 ) + ( fH * 84.16 ) + ( ( 1 - ( fB + fH ) ) * 28. 05 ) )$$

$$H [ wt \% ] = 100 * ( fH * 84.16 ) / ( ( fB * 56.11 ) + ( fH * 84.16 ) + ( ( 1 - ( fB + fH ) ) * 28. 05 ) )$$

### REFERENCES

Klimke, K., Parkinson, M., Piel, C., Kaminsky, W., Spiess, H. W., Wilhelm, M., Macromol. Chem. Phys. 2006;207:382.
Parkinson, M., Klimke, K., Spiess, H. W., Wilhelm, M., Macromol. Chem. Phys. 2007;208:2128. Pollard, M., Klimke, K., Graf, R., Spiess, H. W., Wilhelm, M., Sperber, O., Piel, C., Kaminsky, W., Macromolecules 2004;37:813.
Filip, X., Tripon, C., Filip, C., J. Mag. Resn. 2005, 176, 239.
Griffin, J. M., Tripon, C., Samoson, A., Filip, C., and Brown, S. P., Mag. Res. in Chem. 2007 45, S1, S198.

1Castignolles, P., Graf, R., Parkinson, M., Wilhelm, M., Gaborieau, M., Polymer 50 (2009) 2373 Busico, V., Cipullo, R., Prog. Polym. Sci. 26 (2001) 443.
Busico, V., Cipullo, R., Monaco, G., Vacatello, M., Segre, A. L., Macromoleucles 30 (1997) 6251.
Zhou, Z., Kuemmerle, R., Qiu, X., Redwine, D., Cong, R., Taha, A., Baugh, D. Winniford, B., J. Mag. Reson. 187 (2007) 225.
Busico, V., Carbonniere, P., Cipullo, R., Pellecchia, R., Severn, J., Talarico, G., Macromol. Rapid Commun. 2007, 28, 1128.
Resconi, L., Cavallo, L., Fait, A., Piemontesi, F., Chem. Rev. 2000, 100, 1253.

### Dart Drop Strength (DDI): Impact Resistance by Free-Falling Dart Method

This test method covers the determination of the energy that causes films to fail under specified conditions of impact of a free-falling dart from a specified height that would result in failure of 50% of the specimens tested (ASTM D1709; Alternative testing technique-method A).

By this technique, successive groups of twenty specimens each are tested. One missile weight is employed for each group and missile weight is varied in increments from group to group. Deviating from ASTM D1709-16a the test was performed on several film strips of a sample with at least 4 different weights. 20 specimens per weight were tested, so that a break range of 5%-95% was covered. It must be ensured that at least one weight is determined in the breaking range of 5%-25%, at least two weights in the breaking range of 30%-70%, and at least one weight in the breaking range of 75%-95%. The selection of the weights can be done in uneven steps. A film strip was taken across the width of the sample and measured on a thickness measuring device.

### Standard Conditions:

Conditioning time: >96 h
Test temperature: 23° C.
Dart head material: phenolic
Dart diameter: 38 mm
Drop height: 660 mm

### Results:

Impact failure weight-50% [g].

### Tensile Modulus

Tensile modulus (E-Mod (MPa) was measured in machine and/or transverse direction according to ISO 527-3 on film samples prepared as described under the Film Sample preparation with film thickness of 40 um and at a cross head speed of 1 mm/min for the modulus.

### Haze

Haze was determined according to ASTM D 1003-00 on films as produced indicated below.

Optomechanical ability (OMA) was determined on 40 μm test blown film and was calculated according to formula (II):

$$OMA = \frac{Tensile Modulus ( MD ) [ MPa ] * DDI ( g )}{Haze ( 40 μm ) [ \% ]}$$

wherein the Tensile Modulus in machine direction was measured according to ISO 527-3 at 23° C., DDI is the dart-drop impact strength determined according to ASTM D1709, method A and haze waas measured according to ASTM D1003.

### Film Sample Preparation

The test films consisting of the inventive blend and respective comparative films of 40 μm thickness, were prepared using a W&H semi-commercial line. Film samples were produced with BUR 1:3. Melt temperature ˜222° C. and frost line distance 700 mm, screw speed 126 rpm and take off speed 18.8 m/min.

The blends were prepared directly in the line.

### EXAMPLES

Materials used:
LDPE:
CA9150: LDPE commercially available from Borealis, density is 915 kg/m³ and MFR₂15 g/10 min

### Cat.Example: Catalyst Preparation (CAT1—for Inventive Examples)

### Loading of SiO2:

10 kg of silica (PQ Corporation ES757, calcined 600° C.) was added from a feeding drum and inertized in the reactor until O₂ level below 2 ppm was reached.

### Preparation of MAO/tol/MC:

30 wt % MAO in toluene (14.1 kg) was added into another reactor from a balance followed by toluene (4.0 kg) at 25° C. (oil circulation temp) and stirring 95 rpm. Stirring speed was increased 95 rpm->200 rpm after toluene addition, stirring time 30 min. Metallocene Rac-dimethylsilanediylbis{2-(5-(trimethylsilyl) furan-2-yl)-4,5-dimethylcyclopentadien-1-yl} zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring was turned to 40 rpm during the MAO/tol/MC addition. MAO/tol/MC solution (22.2 kg) was added within 205 min followed by 60 min stirring time (oil circulation temp was set to 25° C.). After stirring “dry mixture” was stabilised for 12 h at 25° C. (oil circulation temp), stirring 0 rpm. Reactor was turned 20° (back and forth) and stirring was turned on 5 rpm for few rounds once an hour.

After stabilisation the catalyst was dried at 60° C. (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Catalyst for Comparative Example CE2 (CAT2)

As catalyst CAT2 an alumoxane containing, supported catalyst containing metallocene bis(1-methyl-3-n-butylcyclopentadienyl) zirconium (IV) chloride with enhanced ActivCat® activator technology from Grace was used.

### Polymerization:

Borstar pilot plant with a 3-reactor set-up (loop1—loop2—GPR 1) and a prepolymerization loop reactor.

mLLDPEs (mLLDPE-1, mLLDPE-2) according to the present invention (for IE1 and IE2) and comparative mLLDPEs (mLLDPE-CE1, mLLDPE-CE2, mLLDPE-CE3 and mLLDPE-CE4; for CE1, CE2, CE3 and CE4) were produced by using the polymerization conditions as given in Table 1.

TABLE 1
Polymerization conditions for inventive mLLDPEs and comparative mLLDPEs

| | mLLDPE-1 | m-LLDPE-2 | | | | |
|---|---|---|---|---|---|---|
| | for IE1 | for IE2 | mLLDPE-CE1 | mLLDPE-CE2 | mLLDPE-CE3 | mLLDPE-CE4 |
| Catalyst | CAT1 | CAT1 | CAT1 | CAT2 | CAT1 | CAT1 |
| Prepoly reactor | | | | | | |
| Catalyst feed (g/h) | 34 | 29.9 | 32 | 17.0 | 27.4 | 35 |
| Temp. (° C.) | 50 | 50 | 50 | 50.0 | 50 | 50 |
| Press. (kPa) | 5621 | 5614 | 5606 | 5692.4 | 5636 | 5639 |
| C2 (kg/h) | 4.0 | 4.0 | 4.0 | 4.0 | 4.0 | 4.0 |
| H2(g/h) | 0.0 | 0.03 | 0.03 | 0.0 | 0.03 | 0.04 |
| C4 (g/h) | 93.7 | 93.1 | 78.8 | 176.3 | 91.2 | 81.9 |
| Split (wt %) | 3.6 | 3.6 | 3.6 | 2.7 | 3.6 | 3.4 |
| loop 1 Fraction (A-1) | | | | | | |
| Temp. (° C.) | 85 | 85 | 85 | 85 | 85 | 85 |
| Press. (kPa) | 5534 | 5536 | 5606 | 5525.5 | 5542 | 5544 |
| C2 conc. (mol %) | 4.3 | 4.3 | 4.0 | 3.5 | 4.4 | 3.5 |
| H2/C2 ratio | 0.89 | 1.34 | 0.39 | 0.1 | 0.46 | 0.41 |
| (mol/kmol) | | | | | | |
| C4/C2 ratio | 77.9 | 88.0 | 41.0 | 33.6 | 43.5 | 41 |
| (mol/kmol) | | | | | | |
| Split (wt %) | 18.4 | 18.2 | 17.9 | 15.6 | 18.2 | 17.6 |
| Density (kg/m3) of | 939.4 | 938.3 | 940.1 | 940 | 941.4 | 941 |
| loop 1 material | | | | | | |
| (fraction (A-1)) | | | | | | |
| MFR2 (g/10 min) of | 35.0 | 120.0 | 2.2 | 0.8 | 6.9 | 5.0 |
| loop 1 material | | | | | | |
| (fraction (A-1)) | | | | | | |
| loop 2 | | | | | | |
| Temp. (° C.) | 85 | 85 | 85 | 85.0 | 85 | 85 |
| Press. (kPa) | 5349 | 5350 | 5335 | 5333.4 | 5345 | 5325 |
| C2 conc. (mol %) | 4.3 | 4.3 | 4.2 | 2.7 | 3.8 | 3.5 |
| H2/C2 ratio | 0.7 | 0.85 | 0.5 | 0.3 | 0.39 | 0.6 |
| (mol/kmol) | | | | | | |
| C4/C2 ratio | 50 | 62.1 | 27 | 201.5 | 32.9 | 29 |
| (mol/kmol) | | | | | | |
| Split (wt %) | 19.8 | 20.2 | 20.7 | 18.9 | 20.1 | 20.4 |
| Density (kg/m3) after | 940.9 | 941.3 | 940.3 | 942.0 | 940.3 | 940.7 |
| loop 2 (component | | | | | | |
| (A)) | | | | | | |
| MFR2 (g/10 min) after | 46.0 | 122 | 4.7 | 6.3 | 7.3 | 5.8 |
| loop 2 (component | | | | | | |
| (A)) | | | | | | |
| MFR2 (g/10 min) of | 62.6 | 124.2 | 10.4 | 45 | 7.8 | 6.8 |
| loop 2 material | | | | | | |
| (fraction (A-2)) | | | | | | |
| Density (kg/m3) of | 942.6 | 944.5 | 940.5 | 944 | 939.1 | 941 |
| loop 2 material | | | | | | |
| (fraction (A-2)) | | | | | | |
| C4 (wt %) after loop 2 | 2.16 | 2.86 | 1.19 | 1.08 | 1.20 | 1.21 |
| material | | | | | | |
| (Component (A)) | | | | | | |
| GPR | | | | | | |
| Temp. (° C.) | 75 | 75 | 75 | 75.0 | 75 | 75.0 |
| Press. (kPa) | 2000 | 2000 | 2000 | 2000.0 | 2000 | 2000.0 |
| H2/C2 ratio | 0.72 | 0.77 | 1.02 | 0.2 | 0.75 | 1.18 |
| (mol/kmol) | | | | | | |
| C6/C2 ratio | 10.24 | 10.06 | 11.78 | 30.3 | 9.58 | 14.5 |
| (mol/kmol) | | | | | | |
| Split (wt %) | 58.3 | 58.1 | 57.9 | 62.8 | 58.2 | 58.6 |
| MFR2 (g/10 min) of | 0.04 | 0.01 | 0.3 | 0.3 | 0.09 | 0.5 |
| GPR material | | | | | | |
| (Component (B)) | | | | | | |
| Density (kg/m3) of | 898.9 | 898.9 | 900 | 902 | 904.4 | 891 |
| GPR material | | | | | | |
| (Component (B)) | | | | | | |
| C6 (wt %) of GPR | 14.41 | 14.14 | 12.08 | 13.22 | 12.01 | 18.60 |
| material | | | | | | |
| Component (B)) | | | | | | |

The polymers were mixed with 2400 ppm of Irganox B561 and 270 ppm of Dynamar FX 5922 compounded and extruded under nitrogen atmosphere to pellets by using a JSW extruder so that the SEI was 230 kWh/kg and the melt temperature 250° C.

TABLE 2
Material properties of mLLDPE-1, mLLDPE-2 and Comparative LLDPEs

| Material | mLLDPE-1 | mLLDPE-2 | mLLDPE-CE1 | mLLDPE-CE2 | mLLDPE-CE3 | mLLDPE-CE4 |
|---|---|---|---|---|---|---|
| MFR₂ (g/10 min) | 0.56 | 0.65 | 1.03 | 0.99 | 0.58 | 1.3 |
| (final) | | | | | | |
| MFR₂₁ (g/10 min) | 22.6 | 28.5 | 29.6 | 20.1 | 18.9 | 38.7 |
| MFR₂₁/MFR₂ | 40.4 | 43.8 | 28.7 | 20.3 | 32.6 | 29.8 |
| Density (kg/m³) | 916 | 916 | 917 | 917 | 919 | 913 |
| C4 (wt %) | 0.9 | 1.2 | 0.5 | 0.4 | 0.5 | 0.5 |
| C6 (wt %) | 8.4 | 8.2 | 7.0 | 8.3 | 7.0 | 10.7 |
| MFR₂(A)/MFR₂(final) | 82.1 | 141.5 | 4.6 | 6.4 | 12.6 | 4.5 |

### Monolayer Blown Films

The above produced mLLDPEs were blended with the LDPE directly on the film extrusion line.

The following films have been produced with the above described method (film sample preparation).

TABLE 3
Inventive and Comparative Films

| | | CE1 | CE2 | CE3 | CE4 | IE1 | IE2 |
|---|---|---|---|---|---|---|---|
| mLLDPE-CE1 | wt % | 90 | — | — | — | — | — |
| mLLDPE-CE2 | w % | — | 90 | — | — | — | — |
| mLLDPE-CE3 | wt % | — | — | 90 | — | — | — |
| mLLDPE-CE4 | wt % | — | — | — | 90 | — | — |
| mLLDPE-1 | | — | — | — | — | 90 | — |
| mLLDPE-2 | | — | — | — | — | — | 90 |
| CA9150 | wt % | 10 | 10 | 10 | 10 | 10 | 10 |
| Film properties | | | | | | | |
| TM/MD | MPa | 200 | 156 | 229 | 145 | 214 | 197 |
| TM/TD | MPa | 242 | 177 | 293 | 170 | 275 | 252 |
| Haze | % | 14.8 | 9.5 | 17.1 | 8.8 | 15.0 | 14.5 |
| DDI | g | 1000 | 1180 | 1230 | 968 | >1790 | >1790 |
| OMA | | 13513 | 19397 | 16472 | 15931 | 25537* | 24319* |

*at least (calculated with DDI 1790 g)

The data demonstrates that using the specific mLLDPE, as described above, blended with LDPE leads to an excellent combination of high DDI, good tensile modulus and good optics. Thus, the overall performance (OMA) of the inventive blends is in addition clearly increased.

1.-15. (canceled)

16. A polyethylene blend comprising:
a) 60.0 wt % to 95.0 wt %, based on a total weight of the polyethylene blend, of a multimodal metallocene catalysed linear low density polyethylene (mLLDPE) which consists of:
(i) 30.0 to 70.0 wt % of an ethylene-1-butene polymer component (A), and
(ii) 70.0 to 30.0 wt % of an ethylene-1-hexene polymer component (B),
whereby the ethylene-1-butene polymer component (A) has:
a density in a range of 930 to 955 kg/m³, and
a MFR₂ (190° C., 2.16 kg, ISO 1133) in a range of 20.0 to 400.0 g/10 min; and
the ethylene-1-hexene polymer component (B) has:
a density in a range of 880 to 915 kg/m³, and
a MFR₂ (190° C., 2.16 kg, ISO 1133) in a range of 0.001 to 0.1 g/10 min;
whereby the multimodal metallocene catalysed linear low density polyethylene (mLLDPE) has:
a density in a range of 905 to 930 kg/m³,
a MFR₂ (190° C., 2.16 kg, ISO 1133) in a range of 0.10 to 0.90 g/10 min,
a ratio of MFR₂₁ (190° C., 21.6 kg, ISO 1133) to MFR₂ (190° C., 2.16 kg, ISO 1133), MFR₂₁/MFR₂, in a range of 22 to 100, and
a ratio of the MFR2 of ethylene-1-butene polymer component (A) to the MFR₂ of the mLLDPE which is in a range of 15.0 to 300.0; and
b) 5.0 to 40.0 wt %, based on the total weight of the polyethylene blend, of a low density polyethylene (LDPE) whereby said LDPE has:
a density in a range of 910 to 930 kg/m³, and
a MFR₂ (190° C., 2.16 kg, ISO 1133) in a range of 0.3 to 30.0 g/10 min.

17. The polyethylene blend according to claim 16, wherein in the multimodal metallocene catalysed linear low density polyethylene (mLLDPE) the ethylene-1-butene polymer component (A) consists of:
an ethylene polymer fraction (A-1) and an ethylene polymer fraction (A-2), wherein the ethylene polymer fraction (A-1) has:
a density in a range of 920 to 955 kg/m³, and/or of 925 to 950 kg/m³, and/or of 930 to 948 kg/m³; and/or
a MFR₂ (190° C., 2.16 kg, ISO 1133) in a range of 10.0 to 800.0 g/10 min, and/or of 15.0 to 400.0 g/10 min, and/or of 20.0 to 300.0 g/10 min, and/or of 25.0 to 200.0 g/10 min; and/or
the ethylene polymer fraction (A-2) has:
a density in a range of from 930 to 955 kg/m³, and/or of 935 to 950 kg/m³; and/or
a MFR₂ (190° C., 2.16 kg, ISO 1133) in a range 10.0 to 800.0 g/10 min, and/or of 15.0 to 400.0 g/10 min, and/or of 20.0 to 300.0 g/10 min, and/or of 25.0 to 200.0 g/10 min.

18. The polyethylene blend according to claim 16, wherein in the multimodal metallocene catalysed linear low density polyethylene (mLLDPE):
the ethylene-1-butene polymer component (A) has a MFR₂ (190° C., 2.16 kg, ISO 1133) of 25.0 to 300 g/10 min, and/or of 30.0 to 250 g/10 min, and/or of 32.0 to 200 g/10 min, and/or of 35.0 to 150.0 g/10 min; and
the ethylene-1-hexene polymer component (B) has a MFR₂ (190° C., 2.16 kg, ISO 1133) of 0.005 to 0.09 g/10 min, and/or of 0.008 to 0.8 g/10 min, and/or of 0.01 to 0.06 g/10 min.

19. The polyethylene blend according to claim 16, wherein in the multimodal metallocene catalysed linear low density polyethylene (mLLDPE) the ratio of the MFR₂₁ (190° C., 21.6 kg, ISO 1133) to MFR₂ (190° C., 2.16 kg, ISO 1133), MFR₂₁/MFR₂ is in a range of from 25 to 60, and/or from 30 to 50, and/or from 35 to 45.

20. The polyethylene blend according to claim 16, wherein in the multimodal metallocene catalysed linear low density polyethylene (mLLDPE) the ratio of the MFR₂ (190° C., 2.16 kg, ISO 1133) of ethylene-1-butene polymer component (A) to the MFR₂ (190° C., 2.16 kg, ISO 1133) of the final multimodal metallocene catalysed linear low density polyethylene (mLLDPE) is 30.0 to 250, and/or of 40.0 to 200, and/or of 50.0 to 160.

21. The polyethylene blend according to claim 16, wherein the multimodal metallocene catalysed linear low density polyethylene (mLLDPE) contains a product of a presence of metallocene complex of formula (I): 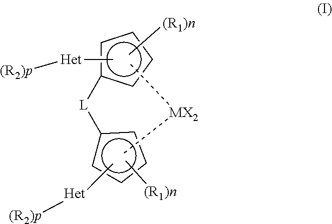
wherein each X is independently a halogen atom, a C₁₋₆-alkyl group, a C₁₋₆-alkoxy group, phenyl or a benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R₁ is the same or different and is a C₁₋₆-alkyl group or C₁₋₆-alkoxy group;
each n is 1 to 2;
each R₂ is the same or different and is a C₁₋₆-alkyl group, a C₁₋₆-alkoxy group or a —Si(R)₃ group;
each R is C₁₋₁₀-alkyl or a phenyl group optionally substituted by 1 to 3 C₁₋₆-alkyl groups; and
each p is 0 to 1.

22. The polyethylene blend according to claim 16, wherein the LDPE has:
a MFR₂ (190° C., 2.16 kg, ISO 1133) in a range of 1.0 to 25.0 g/10 min, and/or in a range of 5.0 to 20.0 g/10 min; and/or
a density in a range of 912 to 925 kg/m³, and/or in a range of 914 to 929 kg/m³.

23. The polyethylene blend according to claim 16, wherein the blend consists of:
a) 65.0 wt % to 93.0 wt %, and/or 75.0 wt % to 92.0 wt %, and/or 80.0 wt % to 92.0 wt %, based on the total weight of the polyethylene blend, of the multimodal metallocene catalysed linear low density polyethylene (mLLDPE); and
b) 7.0 wt % to 35.0 wt %, and/or 8.0 wt % to 25.0 wt %, and/or 8.0 wt % to 20.0 wt %, based on the total weight of the polyethylene blend, of the low density polyethylene (LDPE), wiith total amounts of a)+b) summing up to 100 wt %.

24. A method of preparing a monolayer blown film, the method comprising:
preparing a film from a polyethylene blend containing:
a) 60.0 wt % to 95.0 wt %, based on a total weight of the polyethylene blend, of a multimodal metallocene catalysed linear low density polyethylene (mLLDPE) which consists of:
(i) 30.0 to 70.0 wt % of an ethylene-1-butene polymer component (A), and
(ii) 70.0 to 30.0 wt % of an ethylene-1-hexene polymer component (B),
whereby the ethylene-1-butene polymer component (A) has:
a density in a range of 930 to 955 kg/m³, and
a MFR₂ (190° C., 2.16 kg, ISO 1133) in a range of 20.0 to 400.0 g/10 min; and
the ethylene-1-hexene polymer component (B) has:
a density in a range of 880 to 915 kg/m³, and
a MFR₂ (190° C., 2.16 kg, ISO 1133) in a range of 0.001 to 0.1 g/10 min;
whereby the multimodal metallocene catalysed linear low density polyethylene (mLLDPE) has:
a density in a range of 905 to 930 kg/m³,
a MFR₂ (190° C., 2.16 kg, ISO 1133) in a range of 0.10 to 0.90 g/10 min,
a ratio of MFR₂₁ (190° C., 21.6 kg, ISO 1133) to MFR₂ (190° C., 2.16 kg, ISO 1133), MFR₂₁/MFR₂, in a range of 22 to 100, and
a ratio of the MFR₂ of ethylene-1-butene polymer component (A) to the MFR₂ of the mLLDPE which is in a range of 15.0 to 300.0; and
b) 5.0 to 40.0 wt %, based on the total weight of the polyethylene blend, of a low density polyethylene (LDPE) whereby said LDPE has:
a density in a range of 910 to 930 kg/m³, and
a MFR₂ (190° C., 2.16 kg, ISO 1133) in a range of 0.3 to 30.0 g/10 min.

25. A monolayer blown film containing a polyethylene blend according to claim 16, wherein the film comprises:
a dart-drop impact strength (DDI) determined according to ASTM D1709, method A on a 40 μm monolayer test blown film of at least 1300 g to >1790 g, and/or 1400 g to >1790 g, and/or 1500 g to >1790 g.

26. The monolayer blown film according to claim 25, wherein the film comprises:
a tensile modulus (measured on a 40 um monolayer test blown film according to ISO 527-3) in machine (MD) as well as in transverse (TD) direction in a range of from >160M Pa to 350 MPa, and/or from 180 MPa to 300 MPa; and/or
a haze (measured on a 40 um monolayer test blown film according to ASTM D 1003-00) of below 25%, and/or between 5% and 20%, and/or between 8% and 18%.

27. A monolayer blown film containing a polyethylene blend according to claim 16, wherein the film comprises:
an optomechanical ability (OMA) according to formula (II):
$$OMA = \frac{Tensile Modulus ( MD ) [ MPa ] * DDI ( g )}{Haze ( 40 μm ) [ \% ]} \qquad ( II )$$
determined on 40 um test blown film is at least 20000 [MPa*g/%] up to 50000 [MPa*g/%], and/or in a range of from 22000 [MPa*g/%] up to 45000 [MPa*g/%], and/or in a range of from 23000 [MPa*g/%] up to 40000 [MPa*g/%], wherein the Tensile Modulus in machine direction is measured according to ISO 527-3 at 23° C. on 40 μm test blown films, DDI is the dart-drop impact strength determined according to ASTM D1709, method A on a 40 μm test blown film and haze is measured according to ASTM D1003 on a 40 μm test blown film.

28. A monolayer blown film according to claim 25, wherein the film comprises:
a) a dart-drop impact strength (DDI) determined according to ASTM D1709, method A on a 40 μm monolayer test blown film of at least 1300 g to >1790 g, and/or 1400 g to >1790 g, and/or 1500 g to >1790 g; and
b) a tensile modulus (measured on a 40 um monolayer test blown film according to ISO 527-3) in machine (MD) as well as in transverse (TD) direction in a range of from >160 MPa to 350 MPa, and/or f from 180 MPa to 300 MPa; and/or
c) an optomechanical ability (OMA) according to formula (II):
$$OMA = \frac{Tensile Modulus ( MD ) [ MPa ] * DDI ( g )}{Haze ( 40 μm ) [ \% ]} \qquad ( II )$$
determined on 40 um test blown film is at least 20000 [MPa*g/%] up to 50000 [MPa*g/%], and/or in a range of from 22000 [MPa*g/%] up to 45000 [MPa*g/%], and/or in a range of from 23000 [MPa*g/%] up to 40000 [MPa*g/%], wherein the Tensile Modulus in machine direction is measured according to ISO 527-3 at 23° C. on 40 μm test blown films, DDI is the dart-drop impact strength determined according to ASTM D1709, method A on a 40 μm test blown film and haze is measured according to ASTM D1003 on a 40 μm test blown film.

29. The method according to claim 23, comprising:
applying the film as a packing material for food.

30. The method according to claim 23, comprising:
applying the film as a core layer in multilayer polyethylene based blown film.
